(19) United States
(12) Patent Application Publication
(10) Pub. No.: US 2007/0233297 A1
(43) Pub. Date: Oct. 4, 2007

(54) Simulating manufacturing operations

(76) Inventors: Charles H. Winstead, Portland, OR (US); Daymion T. Reynolds, Mesa, AZ (US); Fernando J. Santiago-Avila, Phoenix, AZ (US); Yashmeet V. Khopkar, Phoenix, AZ (US)

Correspondence Address: TROP PRUNER & HU, PC, 1616 S. VOSS ROAD, SUITE 750, HOUSTON, TX, 77057-2631, US

(21) Appl. No.: 11/394,016

(22) Filed: Mar. 30, 2006

(51) Int. Cl. G06F 17/50; G06F 19/00

(52) U.S. Cl. 700/96; 703/14

(57) ABSTRACT

A manufacturing execution system may be simulated, for example, for volume testing. In a semiconductor fabrication embodiment, a volume capability, such as a number of wafer starts, may be determined for a given version of a manufacturing execution system. In some cases, the simulation runs operations or scripts under more realistic conditions. A check can determine whether an appropriate condition exists at an appropriate lot or tool and the desired operation may then be run from that lot or tool from an appropriate state.

### BACKGROUND

This relates generally to simulating manufacturing operations.

Semiconductor manufacturing facilities may be utilized to manufacture semiconductor integrated circuits using one or more process flows. A process flow is a sequence of operations needed to complete the manufacture of a semiconductor integrated circuit from a semiconductor wafer.

The manufacturing operations may be done at diverse locations within the semiconductor facility. For example, different manufacturing tools may be located across the semiconductor manufacturing facility. Semiconductor wafers in carriers, which collectively are called lots of wafers, may be transported around the facility from location to location and from tool to tool.

The operation of the overall factory, the individual tools, and the transport systems for transporting the lots between tools may be controlled by a manufacturing execution system. The manufacturing execution system controls the processing of material in the fabrication facility.

A manufacturing execution system may track the number of lots, wafers, and die in the system. It may also keep track of which flow each lot is currently being run on. For example, different process flows may be utilized to make different products. These different products may be made using the same machines in the same fabrication facility. Thus, it may be desirable to know which flow a given lot is following.

The manufacturing execution systems generally keep track of the availability state of the various tools or other equipment. Those states may include whether the tool is up and ready for operation, completed an operation, under preventive maintenance, or some other state. In addition, some manufacturing execution systems may track the movement of individual lots, wafers, and die through the fabrication facility.

To some degree, the throughput of the facility is dependent on the capabilities of the manufacturing execution system. The manufacturing execution system may also affect quality by providing processing and flow checks and feedback. It also affects technology development by providing complex information about the processing conditions used to make process improvements. Thus, new features are constantly added to manufacturing execution systems.

The operation of a manufacturing execution system is illustrated in FIG. 5. The manufacturing execution system application 16 communicates with the manufacturing execution system database 22. The database may include information, such as lot tables and lot states, equipment tables and equipment states, experiment tables and experiment states, and flow tables and flow states, as indicated, as well as objects such as special instructions, operator checklists, lot carriers, and much more. In addition, the application 16 may communicate with a reporting data warehouse 24. The warehouse may compile data about the operation of the manufacturing execution system and may formulate reports upon demand or otherwise to provide information about the operation of the fabrication facility.

The manufacturing execution system application may be accessed from personal computers 12b associated with tools. In a conventional manufacturing facility there may be a large number of such tools and a large number of such personal computers (PCs) 12b. Thus, the manufacturing execution system application may be simultaneously accessed by a large number of users.

In the case of a tool PC 12b, a manufacturing technician with a manufacturing execution system user interface 14a may access the application 16. The interface 14a may interface to a controller 14b. The controller 14b may actually control the operation of a given tool 12a.

Examples of tools may include ion implantation machines, deposition chambers, furnaces, and the like. Thus, the actual tool 12a may be controlled by the tool controller 14b. The control of the tool may actually be implemented by the manufacturing execution system application 16. Each tool has a tool state which changes from time to time. In addition, a given lot associated with that tool may have a lot status.

Another group of manufacturing execution system application users include engineers who may use personal computers or laptops 26 to access the manufacturing execution system application 16. These users may not be associated with any particular tool, but may be more involved in the overall management of the manufacturing execution system and the flow through the fabrication facility. The engineering personal computer 26 may include an engineering manufacturing execution user interface 28a, an engineering manufacturing configuration and administration interface, an interface 28b for user reports, and ad hoc queries. Those queries may access the reporting data warehouse 24 in order to provide the engineer directly with information about the status of the manufacturing execution system application and indirectly with information about the operation of the fabrication facility.

There may be many distributed tool personal computers in a fabrication facility that are interacting with the manufacturing execution system. There may be thousands of tools and tool personal computers in a given facility. The manufacturing technician interacts with the user interface on the tool personal computer to change data in the manufacturing execution system about various manufacturing objects, such as lots, wafers, equipment, experiments, and flows.

Each tool interacts with a tool controller on the tool personal computer which, in turn, communicates with the manufacturing execution system about changes in tool states, events occurring on the tool during processing, and the like. There may be many people accessing the application from their personal computers, all interacting with the manufacturing execution system and updating data at the same time.

### BRIEF DESCRIPTION OF THE DRAWINGS

FIG. 1 is a schematic depiction of a simulation engine coupled to a manufacturing execution system in accordance with one embodiment of the present invention;

FIG. 2 is a flow chart for a set up sequence useful in the simulation engine shown in FIG. 1 in accordance with one embodiment;

FIG. 3 is a flow chart for a simulation sequence useful in the simulation engine shown in FIG. 1 in accordance with one embodiment of the present invention;

FIG. 4 is a flow chart for a sequence for running lots, useful in connection with the simulation engine shown in FIG. 1 in accordance with one embodiment of the present invention; and

FIG. 5 is a depiction of how a manufacturing execution system interacts with different users.

### DETAILED DESCRIPTION

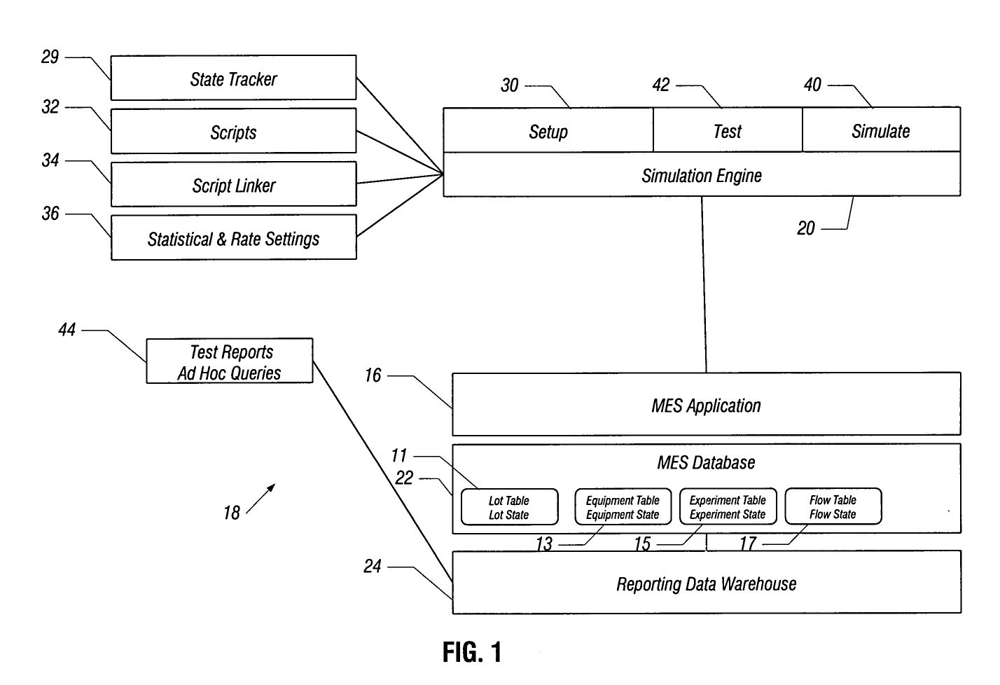

Referring to FIG. 1, a manufacturing system 18 may include a manufacturing execution system application 16, in one embodiment, that may be a layer on top of a manufacturing execution system database 22. Among its many tasks, the database can keep track of all the lots in a lot table 11 while also keeping track of the state of each lot as well. Similarly, a table 13 may keep track of all the equipment in the fabrication facility and the state of each tool. Finally, an experiment table 15 may keep track of all the experiments or experimental lots that may be operating within the fabrication facility at any time. A flow table 17 may keep track of the flow of lots through the fabrication facility and the state of the flow at any time.

A reporting data warehouse 24 stores data from the manufacturing execution system application operation. This data may be useful in generating reports about the status of the manufacturing execution system and the fabrication facility. Test results may be provided in response to ad hoc queries, as indicated at block 44, in one embodiment.

A simulation for new manufacturing execution systems can scale to volume production levels and to identify performance bottlenecks, if they exist. It can also be used to functionally validate changes of manufacturing execution system behavior in an automated manner, thereby reducing the amount of manual testing that is needed in some embodiments. It can also test the performance benefit of system changes in other embodiments.

A simulation engine 20 may be utilized to run a simulation on the manufacturing execution system application 16. As realistically as feasible, the simulation engine 20 may model the actual operation of the manufacturing execution system application 16 in operating a fabrication facility. The simulation engine 20 may implement a set up sequence 30, test sequence 42, and simulate sequence 40, in one embodiment. The set up sequence 30 may be used to set up the simulation and the test sequence 42 may be used to test the simulation that has been set up. Finally, the simulation sequence 40 actually runs the simulation.

The simulation engine 20 may include distinct components, including a state tracker 29. The state tracker may be responsible for keeping track of the state of various tools and lots at any given instance.

In a real semiconductor fabrication facility, for example, certain transactions can only be performed on objects (lots or tools) in a certain state. For example, preventive maintenance may only be performed on a tool that is ready for preventive maintenance. A lot can only be split if the lot is in a pre-move in state of an operation that has been configured for a split. Similar situations exist in non-semiconductor manufacturing and the invention need not be limited to semiconductor manufacturing applications.

The simulation engine 20 advantageously adheres to valid, implicit state restrictions. Without observing these state restrictions, the simulation engine does not produce realistic data.

State management may be done externally to the manufacturing execution system. Otherwise, the load from the simulation engine may affect the performance of the manufacturing execution system being analyzed, improperly skewing the simulation results.

The simulation engine 20 may also use scripts 32. The scripts may be written in XML, in one embodiment, so that people generating the scripts 32 need not be programmers. The scripts 32 model individual tool transactions. Several scripts may represent sequences of transactions that would be undertaken by the manufacturing execution system. The scripts may be linked by the script linker 34 to generate series of scripts in realistic patterns. In some cases, the link may be that one script calls another script. Thus, the linked scripts may represent sequences of transactions in a real fabrication facility, recognizing that in actual facilities certain things are done in particular sequences which may be represented by the scripts and the links between the scripts. In many cases, in a real fabrication facility, there may be hundreds or thousands of transactions and each transaction can happen in a variety of different circumstances.

Finally, the statistical and rate settings 36 may provide limits on the criteria for the simulation. Thus, the rate settings may provide information about the rate of operation of the simulation and the statistics that may be generated.

The simulation engine exercises the manufacturing execution system with realistic life cycles of objects that mimic what happens in a real fabrication. This is done using the scripts and the linking between the scripts. The scripts correspond to simple simulations of transactions such as move a lot, put a lot on hold, split a lot, merge a lot, or rework a lot. The simulation runs the code in the manufacturing execution system as would be done in the actual operation of the facility.

Moreover, the simulation engine may set up the manufacturing execution system with dummy lots and flows to determine how the manufacturing execution system acts in a real operation. This may be done for volume testing. In other words, changes to or new manufacturing execution systems may be volume tested to determine what volume of fabrication (normally in terms of number of wafer starts in a semiconductor application) can be handled by the altered manufacturing execution system. The volume testing may provide a measure of performance of the modified manufacturing execution system.

If unrealistic operations are simulated, the value of the simulation may be reduced. One way that more realistic simulations may be done is to use the state tracker 29 to keep track of the states of different tools in the course of the simulation. In this way, it can be assured that the tool is in an appropriate state before a given operation or script is executed. For example, it may be known that a tool would only do a certain operation if the tool was in a certain state. Thus, the simulation can avoid having tools do operations which are unrealistic because the tool did not happen to be in the appropriate state. When it is desired to do a certain operation, the state tracker can be consulted to determine if one of the tools of a certain class is in the appropriate state to perform that operation.

As an example, it may be undesirable to split a lot at an inappropriate time or under inappropriate conditions. As a result of only splitting the lot appropriately in the simulation, loads are not placed on the manufacturing execution system that would skew results of the simulation. Instead, the state tracker provides information about how to find a lot that is in their correct state to do a transaction like split a lot. Obviously, the quality of the simulation is to some degree dependent upon the skill with which such states are determined and identified.

In some conventional simulation tools, a split-a-lot is run a certain number of times at random time intervals, even though the time when the split-a-lot is run is unrealistic because the lot is in a location or a tool where it would never have been split in the real world. By determining the state of the lot or the tool and only running the split-a-lot under the right conditions, the simulation results may be more realistic.

Thus, in one embodiment, the script that actually is called upon to do a particular operation, such as a split-a-lot, queries the manufacturing execution system database 22 to give it a lot which is in a valid state to be split and the script then splits that lot. However, the engine 20 itself may actually trigger the running of a given operation such as a split-a-lot.

Then, in the course of the simulation, virtual lots are taken from stage to stage through a virtual fabrication facility in which objects are apparently being moved by the manufacturing execution system (without physically doing anything), while requiring the manufacturing execution system to respond as in real life. In some embodiments, the simulation engine 20 dynamically looks up in the state tracker 29 to find a lot in the right state to do an operation that needs to be done periodically. Thus, the operation is done at a realistic state.

The simulation engine may determine how often and when an operation is done. The determination of the frequency may be based on statistics about how often that operation is done in a real fabrication facility. Moreover, when it is done may be based on when such operations are actually undertaken in real fabrication facilities. For example, a given operation may only be run on experimental wafer and in only ten percent of operations. Then the engine will try to run that operation on experimental wafers at the given frequency, finding a lot that is in an appropriate state to actually perform the operation.

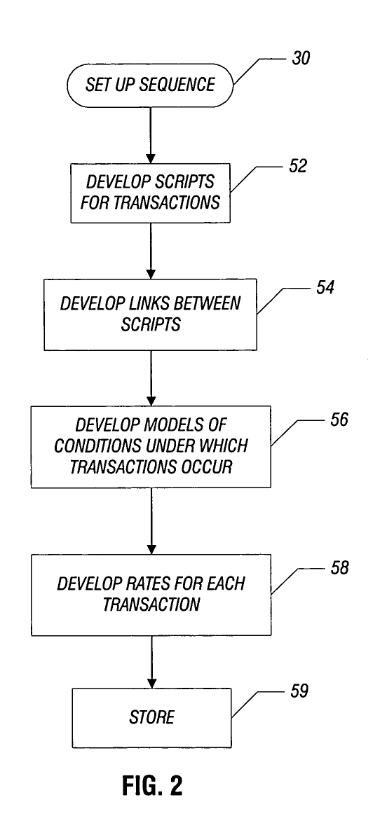

Referring to FIG. 2, the set up sequence 30 may be implemented in software stored on a computer readable medium or in hardware in some embodiments of the present invention. Initially, the scripts are developed for the various transactions, as indicated in block 52. Then, links are developed between the scripts as indicated in block 54.

Models of conditions under which transactions occur are developed as indicated in block 56. The rates or occurrence frequencies for each transaction are then enumerated as indicated in block 58. Then, the simulation data is stored as indicated in block 59.

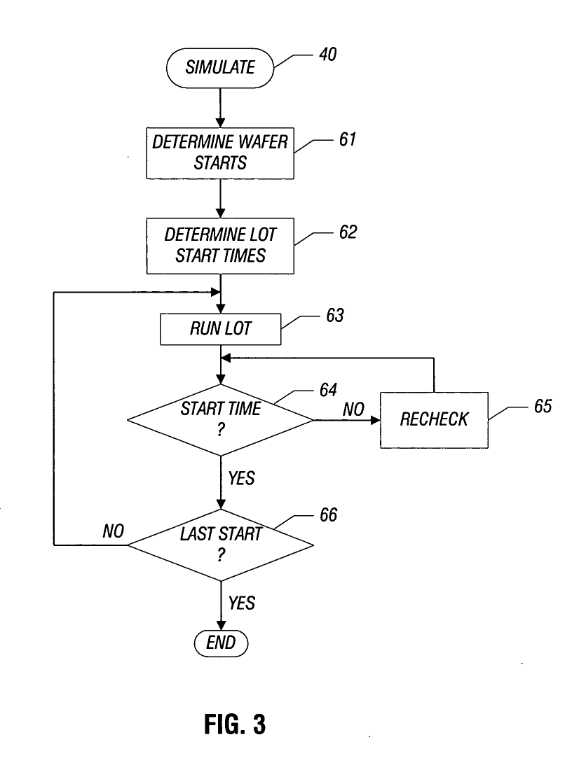

Referring to FIG. 3, the simulate sequence 40, in accordance with one embodiment, may be utilized for volume testing of manufacturing execution systems in one embodiment. It may be implemented in software stored on a computer readable medium. Initially, a volume goal, such as a number of desired wafer starts, may be determined as indicated in block 61. The lot start times may be determined in block 62. Then, the processing of one lot after another is simulated as indicated in block 63.

It should be noted that at any given instance of time, a large number of tools may be operating simultaneously on a large number of lots. Also, at the same time, events are being logged against equipment independently of a lot and many read only transactions may be run independently of the lot. Hundreds or thousands of threads may be executing at a time to process many lots, examine tools, and make read only calls against the database, as well as starting new lots and terminating completed lots.

At diamond 64, a check may determine whether or not the start time for a lot has been reached. If not, a recheck occurs at block 65. If so, the lot is run and then a check at diamond 66 determines whether the simulation has been running for the required amount of time. If not, the flow iterates and, otherwise, the flow ends.

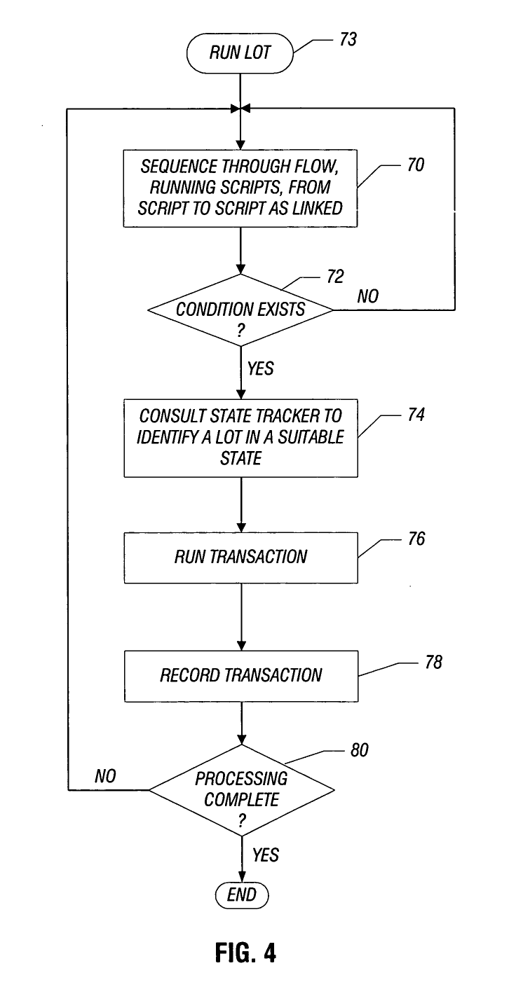

Moving to FIG. 4, in accordance with one embodiment of the present invention, a run lot sequence 73 initially sequences through a process flow, running scripts from script to script as linked as indicated in block 70. The sequence 73 may be implemented by software stored on a computer readable medium in one embodiment. If a given condition exists, as determined in diamond 72, the state tracker may be consulted to identify a lot in a suitable state as indicated in block 74.

In other words, if the simulation engine 20 indicates that a certain operation needs to occur, a check may be undertaken to determine whether the condition appropriate for that event is available on some specific lot or some specific tool. If so, the transaction is run, as indicated in block 76, and the results of the transaction may be recorded as indicated in block 78. If processing is complete, as determined in diamond 80, the flow stops. Otherwise, it continues to iterate through the flow, running scripts from script to script, as linked, (block 70).

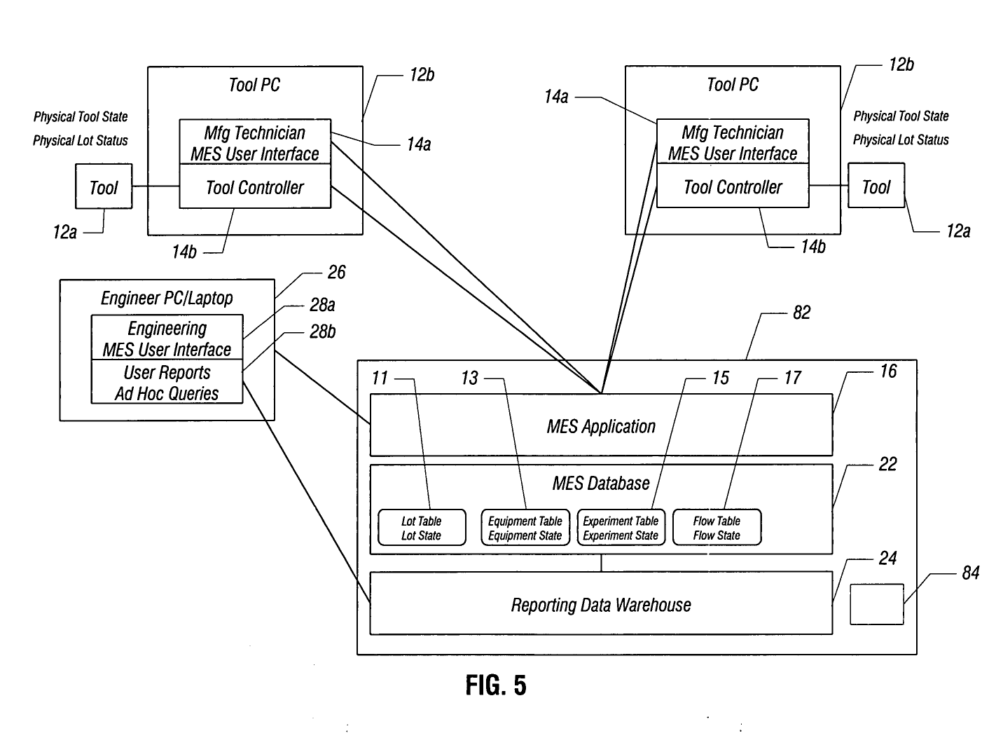

Finally, referring to FIG. 5, a fabrication facility is depicted which includes tool personal computers 12b, tools 12a, engineer personal computers 26, and a server 82. The server 82 includes the manufacturing execution system application 16, the database 22, and the data warehouse 24. In one embodiment, the server 82 includes a storage 84 which stores the simulation engine 20 (FIG. 1), the set up sequence 30 (FIG. 1), the test sequence 42 (FIG. 1), and the simulate sequence 40 (FIG. 1), which may all be implemented in software in one embodiment of the present invention.

As an example, a simulation can be run to test a new manufacturing execution system (MES) feature of implementing automated execution of special processing instructions. This feature is developed and implemented in the MES. Next, the MES system runs a series of tests at low volume, to validate the functionality of the changes. New tests may be added to the system for this new functionality. It is determined that the changes made break some previously functioning capability, so the code for the new feature is revised and retested using the simulation engine 20. The engine 20 validates that the system is functioning correctly. Next, the volume of the transactions is increased to high-volume levels, and it is determined that the performance of the new feature under volume is too slow. The code for the new feature is revised, with data being provided from the simulation engine 20 on which aspect of the code is causing the performance degradation. The new functionality is again tested, both at low volume to ensure that it is functionally working, and at high volume, to ensure that the feature is scalable.

Another example is that a volume test indicates that the MES looses performance at a certain rate of transactions, and the MES database is determined to be the bottleneck. A new MES database platform may be introduced, with more memory or processors, and the volume test rerun to see if the MES can now scale to higher volumes of transaction rates without loosing performance.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining whether a particular state exists that is appropriate for a specific operation; and
if the state exists, simulating the operation from the appropriate state on a manufacturing execution system.

2. The method of claim 1 including simulating the manufacture of a semiconductor integrated circuit.

3. The method of claim 1 including volume testing a manufacturing facility.

4. The method of claim 1 including testing architectural changes to a manufacturing execution system.

5. The method of claim 1 including simulating the processing of a plurality of lots through a manufacturing facility.

6. The method of claim 5 including determining the simulated state of a simulated lot at a simulated tool.

7. The method of claim 6 including only simulating a given operation on a lot which is in a predetermined appropriate state to have the operation run on the lot.

8. The method of claim 1 including determining whether to run a given operation based on the state of a lot, the state of a tool that simulates the processing of a lot, and the frequency with which an operation is run.

9. The method of claim 1 including using a plurality of scripts in XML corresponding to manufacturing operations run on lots.

10. The method of claim 1 including providing links from one script to another in order to build a sequence of operations made up of a sequence of scripts.

11. The method of claim 10 including controlling the sequence of operations from script to script to simulate real operations done in a manufacturing facility.

12. A computer readable medium storing instructions that, if executed, enable a system to:
determine whether a particular state exists that is appropriate for a specific operation; and
if the state exists, simulate the operation from the appropriate state on a manufacturing execution system.

13. The computer readable medium of claim 12 further storing instructions to simulate the manufacture of a semiconductor integrated circuit.

14. The computer readable medium of claim 12 further storing instructions to volume test a manufacturing facility.

15. The computer readable medium of claim 12 further storing instructions to simulate the processing of a plurality of lots through a manufacturing facility.

16. The computer readable medium of claim 15 further storing instructions to determine the simulated state of a simulated lot at a simulated tool.

17. The computer readable medium of claim 16 further storing instructions to only simulate a given operation on a lot which is in a predetermined appropriate state to have the operation run on the lot.

18. The computer readable medium of claim 12 further storing instructions to determine whether to run a given operation based on the state of a lot, the state of a tool that simulates the processing of a lot, and the frequency with which an operation is run.

19. The computer readable medium of claim 12 further storing instructions to develop a plurality of scripts corresponding to manufacturing operations run on lots.

20. The computer readable medium of claim 12 further storing instructions to provide links from one script to another in order to build a sequence of operations made up of a sequence of scripts.

21. The computer readable medium of claim 20 further storing instructions to control the sequence of operations from script to script to simulate real operations done in a manufacturing facility.

22. A fabrication facility comprising:
a plurality of tools; and
a server coupled to said tools, said server including a state tracker to indicate whether a particular state exists that is appropriate for a specific operation and a simulation engine to simulate the operation from the appropriate state on a manufacturing execution system.

23. The facility of claim 22 wherein said facility is a semiconductor manufacturing facility.

24. The facility of claim 22 including a manufacturing execution system stored on said server.

25. The facility of claim 24 wherein said manufacturing execution system to operate said tools.

26. The facility of claim 25 wherein said simulation engine to simulate the operation of said manufacturing execution system for volume testing.
